(19) United States
(12) Patent Application Publication
(10) Pub. No.: US 2005/0013472 A1
(43) Pub. Date: Jan. 20, 2005

(54) Lumber recognizing system

(76) Inventor: Christian Gauthier, St-Jean-sur (CA)

Correspondence Address: THE LAW OFFICE OF RANDALL T. ERICKSON, P.C., 425 WEST WESLEY STREET, SUITE 1, WHEATON, IL, 60187, US

(21) Appl. No.: 10/488,114

(22) PCT Filed: Sep. 3, 2002
(86) PCT No.: PCT/CA02/01354

(30) Foreign Application Priority Data
Aug. 31, 2001 (CA) 2356477

(51) Int. Cl. G06K 9/00

(52) U.S. Cl. 382/141; 382/110

(57) ABSTRACT

A system (10) for identifying pieces of lumber (L), comprising an identifying apparatus (12) having an imaging device (22, 100) to obtain images and a database (24) to record the images. The identifying apparatus (12) is adapted for identifying pieces of lumber (L). The system (10) is adapted for being connected to at least one of a data source (16, 126, 128) for receiving qualitative data on pieces of lumber (L) and an output destination (18, 130) to transfer at least an identification of a piece of lumber (L) thereto.

### BACKGROUND OF THE INVENTION

1. Field of the Invention

The present invention generally relates to the lumber industry and, more particularly, to lumber handling equipment.

2. Description of the Prior Art

Plants in the lumber industry are known to be fully automated throughout the various steps of producing various pieces of lumber from the wood in its rough state, i.e., the timber. The various stages of a typical lumber processing line, which include debarking, sawing, sanding, planing, trimming and packaging operations, are performed by machinery and equipment operating with very little human input and/or intervention.

Another area of operation that has evolved towards automation is the grading of the lumber pieces. The grading operation enables to classify a lumber piece according to its overall quality. More precisely, criteria such as the wood quality (including the grain, growth rings, presence of knots, stains) and the geometric integrity of the piece (full surfaces, square corners, checks, splits, wanes, etc . . . ) are applied in digitally inspecting the pieces of lumber, to enable classification of the lumber pieces according to grades. Subsequently, the lumber pieces are assembled and packed in grade groups, and this is necessary for the sale of the lumber.

According to one system for ensuring the transition of the pieces of lumber from the grading to the packaging, synchronizing mechanisms relate the position of a lumber piece on a conveyor to its grade determination. In other words, a lumber piece carried by a given stop (i.e., lug) on the conveyor will be given a grade. At the sorting stage and/or packaging stage, an operating system will relate the grade obtained previously to the given stop and hence to the lumber piece supported by that given stop. However, conveying speeds are increasingly faster (up to 2500 ft/min), and synchronizing mechanisms can be speed limits to the operation of lumber processing lines.

Canadian Patent No. 2,245,412, issued on Jun. 26, 2001 to Labbé et al., discloses an apparatus and method for marking elongated articles. The apparatus comprises a marking station whereat a lumber piece is marked with identity information, i.e., an identification code or a grade/dimension. More precisely, the marking station is equipped with ink-jet devices that apply the given marks to the lumber pieces. A reading station is provided downstream of the marking station, and is equipped with optical sensing devices that will determine the identity of the pieces of lumber according to the marking, to then relate the identity to other information about the pieces of lumber, which information is stored in an operating system. As mentioned in Canadian Patent No. 2,245,412, a luminescent ink is used along with a luminescence inducing light source at the reading station, such that the marking does not stain the pieces of lumber.

However, the ink-marking is somewhat problematic when performed on wet or frozen pieces. The lumber piece identity can be lost as a result of unreadable marking, due for instance to the thawing of the lumber piece, which blurs the marking to render same unidentifiable. Or else, impregnation of the ink to a wet surface is not readily performable. Furthermore, luminescent ink is an additional non-negligible cost.

Errors in classification of lumber pieces can result in substantial losses of profits. For instance, high grade lumber classified under lower grades will be sold undervalue. Similarly, refunds could be requested by unsatisfied lumber purchasers complaining about quality.

Every piece of lumber intrinsically has its own identity, as it is the case for all living beings. By identifying the characteristics proper to a lumber piece, that lumber piece has a fingerprint. Therefore, an identity may be given to that lumber piece, which can be unmistakably reestablished, provided that the piece of lumber is not altered after having been given an identity. The characteristics that can be used in the identification of the fingerprint of the piece of lumber include the grain, knots, growth rings and/or stains.

### SUMMARY OF THE INVENTION

It is an aim of the present invention to provide a lumber recognizing system using biometrics to identify lumber pieces.

It is a further aim of the present invention to provide a method of use of the above mentioned lumber recognizing system.

Therefore, in accordance with the present invention, there is provided a method for identifying a piece of lumber, comprising the steps of: i) recording a fingerprint of a piece of lumber by obtaining at least a first image of a portion of the piece of lumber; and ii) identifying the piece of lumber by obtaining at least a second image of said portion of the piece of lumber and comparing said second image to the fingerprint of the piece of lumber.

Further in accordance with the present invention, there is provided a system for identifying pieces of lumber, comprising an identifying apparatus having an imaging device to obtain images and a database to record the images, the identifying apparatus being adapted for identifying pieces of lumber as described above; and wherein the system is adapted for being connected to at least one of a data source for receiving qualitative data on pieces of lumber and an output destination to transfer at least an identification of a piece of lumber thereto.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a block diagram illustrating a lumber recognizing system in accordance with the present invention;

FIG. 2 is a block diagram illustrating the lumber recognizing system in further detail;

FIG. 3, is a flow chart illustrating a method of operating the lumber recognizing system;

FIG. 4A is a front elevational view of an identifying/storing apparatus in accordance with the present invention;

FIG. 4B is a side elevational view of the identifying/storing apparatus of FIG. 4A;

FIG. 5 is a side elevational view of a recognition apparatus in accordance with the present invention; and

FIG. 6 is a top plan view of a lumber processing line with the lumber recognizing system in parallel thereto.

### DESCRIPTION OF THE PREFERRED EMBODIMENTS

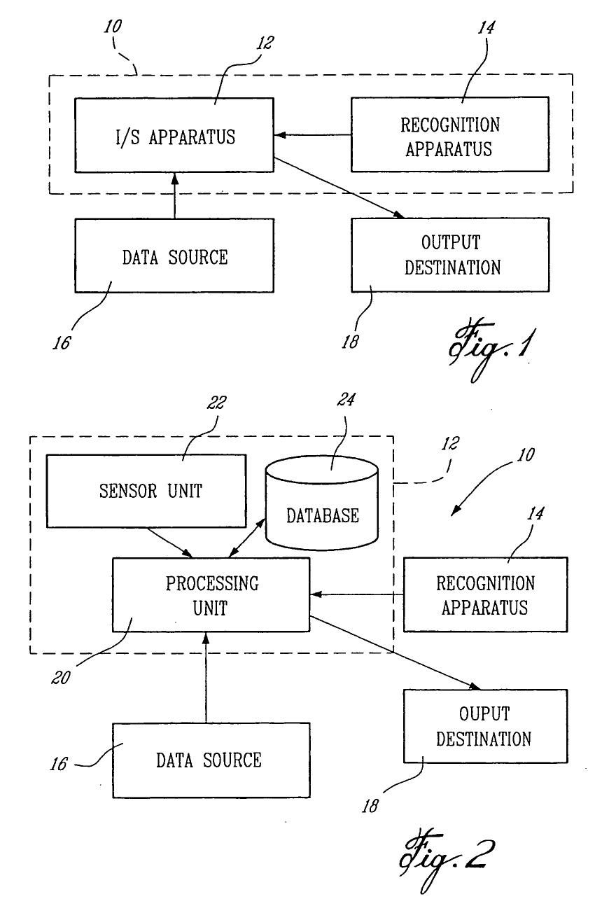

Referring to the drawings, and more particularly to FIG. 1, a lumber recognizing system is generally shown at 10. The lumber recognizing system 10 (hereinafter LR system 10) has an identifying/storing apparatus 12 (hereinafter I/S apparatus 12) and a recognition apparatus 14, which are interconnected to one another for data transfer therebetween. A data source 16 and an output destination 18 are wired to the I/S apparatus 12 of the LR system 10.

Basically, the LR system 10 is incorporated in parallel to a typical lumber processing line, wherein timber is transformed into lumber pieces. The LR system 10 operates to give an identity to the lumber pieces conveyed at a given stage of the lumber processing line, to receive data associated with each lumber piece, and to recognize the identity of each single lumber piece it has previously identified.

More specifically, the I/S apparatus 12 has the function of giving an identity to pieces of lumber. The I/S apparatus 12 proceeds by gathering biometric information on each single lumber piece, by obtaining and storing visual data of a surface portion of each lumber piece. By its nature, each piece of lumber will have its own fingerprint. The fingerprint of each given lumber piece will be defined by the characteristics of its surface, namely the grain, growth rings, knots, and/or stains. It is noted that the fingerprint of a lumber piece is not altered by wood humidity or wood temperature. This will be discussed in further detail hereinafter.

On the other hand, the recognition apparatus 14 will also obtain visual data on each lumber piece, and this visual data will be matched with the visual data gathered and stored by the I/S apparatus 12 in the recognition of the pieces of lumber.

Once an identity (i.e., fingerprint) is given to a piece of lumber, supplemental data regarding that piece of lumber can be acquired and stored in association with the identity of the piece of lumber. For instance, information on the quality (i.e., grade), size, defects and the like can be associated with the identity of the lumber piece. Accordingly, when the recognition apparatus 14 recognizes a piece of lumber by detecting its fingerprint, the LR system 10 has on hand the supplemental data, such that the lumber piece can be, for instance, packed and/or sorted amongst lumber pieces of a same grade by the forwarding of the supplemental information to the output destination 18. The supplemental data is to be provided to the LR system 10 by the data source 16.

Referring to FIG. 2, an embodiment of the LR system 10 is shown in greater detail. The I/S apparatus 12 has a processing unit 20, a sensor unit 22 and a database 24. The sensor unit 22 and the database 24 are operatingly wired to the processing unit 20. As an example of a suitable embodiment, the processing unit 20 can be the RAM and the processor of a PC unit, with the database 24 being the hard disk. It is noted that the various components can be interconnected by wireless communication devices, optical fiber, or any other suitable telecommunications means.

The processing unit 20 is adapted to operate the LR system 10, by acquiring the visual data through the sensor unit 22 and storing the visual data in the database 24. Moreover, the processing unit 20 is operatingly connected to the recognition apparatus 14, and performs the comparison between the fingerprint acquired by the sensor unit 22 and the recognition apparatus 14, to identify the pieces of lumber. The processing unit 20 must thus be supplied with software adapted to perform biometric comparisons.

The sensor unit 22 acquires the visual data of the surface of each piece of lumber. Hence, the sensor unit 22 has an imaging device. In an embodiment, the sensor unit 22 has a digital camera, equipped with a light source (i.e., flash), to take a picture of suitable resolution of a predetermined surface portion of the lumber piece. Obviously, in the recognition stage, a picture will be taken of the same predetermined surface portion of the lumber piece. In order not to reduce the processing speed of the lumber processing line, it is preferred that the sensor unit 22 takes pictures of moving lumber pieces. Therefore, the digital camera must operate at fast shutter speeds.

Strategically, the sensor unit 22 is provided with a motion detector (e.g., photocell, proximity switch) upstream of its digital camera. Accordingly, a moving lumber piece will trigger the operation of the digital camera, through the motion detector. As will be discussed in further detail hereinafter, it also is possible to use motion pictures instead of stills. Obviously, this would require increased processing speeds for the processing unit 20.

Still referring to FIG. 2, the recognition apparatus 14 is operatingly connected to the I/S apparatus 12 and, more precisely, to the processing unit 20. Like the sensor unit 22, the recognition apparatus 14 acquires the visual data of the predetermined surface portion of each piece of lumber. However, the visual data will not be used to create a fingerprint for the surface the of pieces of lumber, but rather to provide the data to the processing unit 20 such that a biometric comparison can be effected to recognize the identity of the piece of lumber. Therefore, the recognition apparatus 14 has an imaging device, such as a digital camera equipped with a flash, and is adapted to operate at appropriate shutter speeds, still frequency (e.g., 250 stills per minute) and light intensity.

The recognition apparatus 14 is thus located downstream of the I/S apparatus 12 in the lumber processing line with perhaps various stages of the lumber processing line in parallel thereto. These various stages will include the data source 16 that will supply data to the LR system 10. The recognition apparatus 14 includes a motion detector to synchronize the taking of the still with the passing of the lumber piece.

Strategically, the recognition apparatus 14 has a pair of imaging devices. Considering that the pieces of lumber can be turned in the operations taking place between the I/S apparatus 12 and the recognition apparatus 14, having two imaging devices, an upper and a lower one, will ensure that the precise predetermined surface portion that was used to create the fingerprint of the lumber piece will be scanned at the recognition stage. Obviously, the lumber processing line will have mechanisms that will ensure that the lumber pieces will be aligned with respect to the recognition apparatus 14 as they were for the I/S apparatus 12 (i.e., the sensor unit 22 of the I/S apparatus 12) such that the precise predetermined surface portion is taken in both stills.

Once the visual data has been taken by the recognition apparatus 14, it is forwarded to the processing unit 20 of the I/S apparatus 12, which will perform a comparison of the visual data to the various fingerprints it has gathered in the database 24. The comparison will permit to recognize the identity of the piece of lumber.

Thereafter, the identity of the piece of lumber and the information associated therewith that had previously been stored in the database 24 are forwarded to the output destination 18. For example, the output destination 18 can be an automatic end-trimmer and/or an automatic lumber sorter that will take the piece of lumber and direct it to a packaging section according to the grade (i.e., the associated information in the database 24) of the piece of lumber. Or, the output destination 18 can simply be an output screen that will display the information associated to the piece of lumber, such that a human operator can be guided in the disposal of the piece of lumber.

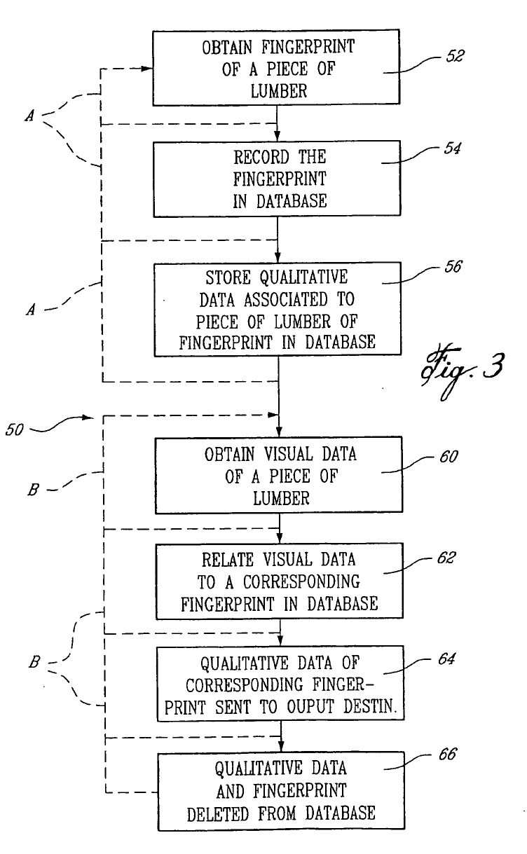

Referring to FIG. 3, a method of operation of the LR system 10 is shown in detail at 50. According to Step 52, the fingerprint of a lumber piece is obtained. As mentioned previously, this step is performed by the I/S apparatus 12 and, more precisely, by the sensor unit 22.

According to Step 54, the fingerprint of the piece of lumber is recorded. The processing unit 20 stores the fingerprint of the lumber piece, obtained by the sensor unit 22 in Step 52, in the database 24.

According to Step 56, qualitative data associated with the lumber piece is stored in the database as a function of the fingerprint. The qualitative data is forwarded to the database 24 by the data source 16, and has been gathered either upstream or downstream of the I/S apparatus 12. The qualitative data, as mentioned previously, is classification information, such as the grade or other quality information about the lumber piece.

Steps 52 to 56 are repeated as lumber pieces are conveyed before the LR system 10. The database 24 thus receives a plurality of fingerprints (e.g., between 250 and 500 fingerprints). Moreover, as shown by reference lines A, Step 52 can be repeated for different pieces of lumber before the Steps 54 and 56 are reached.

According to Step 60, visual data is obtained for a lumber piece. That lumber piece has already gone through Steps 52 to 56, and thus has a fingerprint and qualitative data associated therewith in the database 24. The visual data is obtained by the recognition apparatus 14.

According to Step 62, the visual data obtained in Step 60 is related to a fingerprint, to determine the identity of the lumber piece. More precisely, the recognition apparatus 14 forwards the visual data to the processing unit 20 of the I/S apparatus 12, which will perform a comparison between fingerprints and the visual data. As mentioned previously, the visual data must come from the same predetermined surface portion that was used to provide the fingerprint in Step 52. Therefore, the lumber processing line preferably ensures the alignment of the lumber piece for the gathering of the visual data. It was also mentioned previously that the use of a pair of digital cameras for the recognition apparatus 14 was contemplated. It is obvious that the operations taking place between Steps 52 and 62 must in no way alter the predetermined surface portion of the lumber piece. For example, planing operations could not take place between Steps 52 and 62.

According to Step 64, once the fingerprint is matched and thus the identity of the lumber piece determined, the qualitative data is forwarded to the output destination 18. Therefore, the qualitative data in the database 24 is transferred to the processing unit 20 (i.e., to the RAM of the processing unit 20), to then be forwarded to the output destination 18, which will be any of a plurality of equipment requiring that qualitative data.

Optionally, according to Step 66, the qualitative data and the fingerprint pertaining thereto are deleted from the database once a lumber piece has been identified. The qualitative data and fingerprint could be used some more in various lumber processing lines, but are preferably deleted to free up some space in the I/S apparatus 12.

Reference lines B indicate that the Steps 60 to 66 can be performed simultaneously for a plurality of lumber pieces. The reference lines A and B of FIG. 3 are in broken lines as they are provided to illustrate a repetition of the steps of the method 50 for a plurality of lumber pieces. It is pointed out, however, that each single lumber piece goes through the Steps 52 to 66 of the method in the order illustrated at 50.

It is pointed out that the group of Steps 52 to 56 and group of Steps 60 to 66 associated therewith can be performed at various locations. Therefore, a container of randomly stored lumber pieces can be shipped from a plant to another along with a diskette containing the information gathered by the database 24.

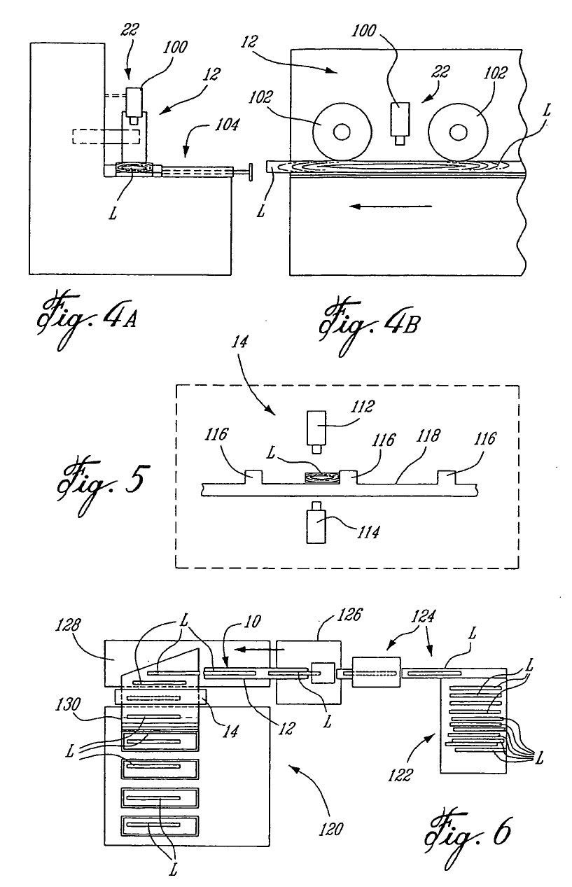

Referring to FIGS. 4A and 4B, the I/S apparatus 12 is shown obtaining a fingerprint of a piece of lumber L. The sensor unit 22 is shown having a camera 100. An example of a suitable camera to be used as the camera 100 is the Piranha 2™, P2-2X black and white camera, operating at a shutter speed of 10 microseconds, with a 14 CCD (having the capacity of taking 500 stills/minute, in some cases 1000 stills/minute), and a 1024×2448 resolution. The P2-2X camera is equipped with NEMA-12 lighting, and possibly with a filter to correct light defects. Rollers 102 ensure the displacement of the lumber piece L, and a displaceable anvil 104 stabilizes and aligns the lumber piece L in position with respect to the camera 100.

Referring to FIG. 5, the recognition apparatus 14 is shown having two cameras, namely upper camera 112 and lower camera 114. The cameras 112 and 114 are typically, but not necessarily, of the same brand and model as the camera 100 of FIGS. 4A and 4B. Each lumber piece L in the process of being filmed is displaced by a stop 116 of a respective conveyor 118.

Referring to FIG. 6, a lumber processing line is generally shown at 120, and the LR system 10 is shown incorporated therein. The lumber pieces L are initially transferred from an unstacking machine 122 to a planing machine 124. A grading machine 126, will then gather qualitative data about each lumber piece. Therefore, the grading machine 126 will become the data source (i.e., 16 in FIG. 1) that will forward the qualitative data to be associated with a fingerprint (i.e., Step 56 in FIG. 3). Thereafter, various operations will take place at station(s) 128, until the lumber pieces L are sorted at sorting station 130 after having been recognized at the recognition apparatus 14. Therefore, the output destination 18 corresponds to the sorting being performed at 130.

The LR system 10 is advantageous as no costs are involved once installed, aside from energy consumption and typical maintenance. The LR system 10 can be encased to be sheltered from dust and humidity inherent to a lumber processing plant.

In optimizing the accuracy of the LR system 10, a plurality of stills can be taken for each single lumber piece. Similarly, a motion picture could also be taken, to thereafter be separated in a plurality of stills, as known in the art. The same amount of stills could then be taken at the same predetermined surface portions on the lumber pieces at the recognition stage.

The I/S apparatus 12 illustrated in FIGS. 1 and 2 can be used by itself to execute the method shown at 50 in FIG. 3. More specifically, as the I/S apparatus 12 is equipped with sensor unit 22, it can be used to obtain a fingerprint and recognize the fingerprint thereafter, considering that the recognition apparatus 14 simply obtains images and forwards them to the processing unit 20 of the I/S apparatus 12. However, the use of the I/S apparatus 12 by itself for completing all steps of the method (illustrated at 50 in FIG. 3) is not optimal with regards to the present invention as, for instance, lumber pieces would have to be re-routed to the I/S apparatus 12, or the latter would have to be displaced. Hence, although a stand-alone I/S apparatus 12 is contemplated, it is not preferred in the present invention.

As for the software to be used for the operation of the processing unit 20 of the LR system 10, it may be chosen amongst various fingerprint image processing software. As mentioned previously, the characteristics of lumber are to be used to create a fingerprint of lumber pieces, and these characteristics include grain, growth rings, knots and stains. As an example, Idée inc. has developed image processing software for human fingerprint recognition, which software could be adapted to be used for the fingerprint of lumber.

1. A method for identifying a piece of lumber, comprising the steps of:
i) recording a fingerprint of a piece of lumber by obtaining at least a first image of a portion of the piece of lumber; and
ii) identifying the piece of lumber by obtaining at least a second image of said portion of the piece of lumber and comparing said second image to the fingerprint of the piece of lumber.

2. The method according to claim 1, further comprising a step of receiving qualitative data of the piece of lumber and storing the qualitative data of the piece of lumber as a function of the fingerprint after step i), such that the qualitative data of a piece of lumber is outputted when the piece of lumber is identified in step ii).

3. The method according to claim 2, wherein the qualitative data is related to a geometric integrity of the piece of lumber.

4. The method according to claim 1, wherein step i) is repeated to record fingerprints of a plurality of pieces of lumber, and step ii) is performed to identify a given piece of lumber amongst the plurality of pieces of lumber.

5. The method according to any one of claims 2 and 3, wherein step i) and the step of storing qualitative data are repeated to record fingerprints and qualitative data of a plurality of pieces of lumber, and step ii) is performed to identify a given piece of lumber amongst the plurality of pieces of lumber.

6. The method according to any one of claims 2, 3 and 5, further comprising a step iii) of transferring the qualitative data relating to fingerprints to an output destination.

7. The method according to claim 6, wherein the output destination is a sorting apparatus for sorting pieces of lumber as a function of said qualitative data.

8. The method according to any one of claims 1 to 7, wherein the first image is one of a still and a motion picture.

9. The method according to any one of claims 1 to 8, wherein the fingerprint is characterized by at least one of the grain, growth rings, knots and stains of said portion of the piece of lumber.

10. A system for identifying pieces of lumber, comprising:
an identifying apparatus having an imaging device to obtain images and a database to record the images, the identifying apparatus being adapted for identifying pieces of lumber according to any one of claims 1 to 9;
wherein the system is adapted for being connected to an output destination to transfer at least an identification of a piece of lumber thereto.

11. A system for identifying pieces of lumber, comprising:
an identifying apparatus having an imaging device to obtain images and a database to record the images, the identifying apparatus being adapted for identifying pieces of lumber according to any one of claims 1 to 9; and
wherein the system is adapted for being connected to at least one of a data source for receiving qualitative data on pieces of lumber and an output destination to transfer at least an identification of a piece of lumber thereto.

12. The system according to claim 11, wherein the system is mounted to a lumber processing line so as to identify pieces of lumber conveyed on the lumber processing line and transfer at least an identification of a piece of lumber to the output destination of the lumber processing line.

13. The system according to any one of claims 11 and 12, further comprising a recognition apparatus downstream of the identifying apparatus, the recognition apparatus having an imaging device and being adapted for providing the identifying apparatus with said second image.
